(19) United States
(12) Patent Application Publication
(10) Pub. No.: US 2015/0375799 A1
(43) Pub. Date: Dec. 31, 2015

(54) ELASTICALLY AVERAGED ALIGNMENT SYSTEMS AND METHODS

(71) Applicant: GM GLOBAL TECHNOLOGY OPERATIONS LLC, Detroit, MI (US)

(72) Inventors: Steven E. Morris, Fair Haven, MI (US); Jennifer P. Lawall, Waterford, MI (US)

(21) Appl. No.: 14/319,745

(22) Filed: Jun. 30, 2014

(51) Int. Cl. B62D 27/04; B62D 27/06

(52) U.S. Cl. CPC B62D 27/04; B62D 27/06

(57) ABSTRACT

In one aspect, an elastically averaged alignment system is provided. The system includes a first component comprising a tubular alignment member, a second component comprising an inner wall defining an alignment aperture, the alignment aperture configured to receive the alignment member to couple the first component and the second component, and a third component comprising a locking member configured for insertion into the alignment member. The alignment member is an elastically deformable material that elastically deforms to an elastically averaged final configuration to facilitate aligning the first component and the second component in a desired orientation. The locking member is an elastically deformable material such that when the locking member is inserted into the alignment member, the locking member elastically deforms and forces the alignment member outward toward the inner wall to facilitate securing the first component to the second component in the desired orientation.

### FIELD OF THE INVENTION

The subject invention relates to matable components, and more specifically, to elastically averaged matable components for alignment and retention.

### BACKGROUND

Components, in particular vehicular components used in automotive vehicles, which are to be mated together in a manufacturing process are mutually located with respect to each other by alignment features that are oversized holes and/or undersized upstanding bosses. Such alignment features are sized to provide spacing to freely move the components relative to one another to align them without creating an interference therebetween that would hinder the manufacturing process. One such example includes two-way and/or four-way male alignment features, typically upstanding bosses, which are received into corresponding female alignment features, typically apertures in the form of slots or holes. The components are formed with a predetermined clearance between the male alignment features and their respective female alignment features to match anticipated size and positional variation tolerances of the male and female alignment features that result from manufacturing (or fabrication) variances.

As a result, significant positional variation can occur between two mated components having the aforementioned alignment features, which may contribute to the presence of undesirably large variation in their alignment, particularly with regard to gaps and/or spacing therebetween. In the case where misaligned components are also part of another assembly, such misalignments may also affect the function and/or aesthetic appearance of the entire assembly. Regardless of whether such misalignment is limited to two components or an entire assembly, it can negatively affect function and result in a perception of poor quality. Moreover, clearance between misaligned components may lead to relative motion therebetween, which may cause undesirable noise such as squeaking and rattling.

Additionally, some components, particularly components made of compliant materials, may not remain mated to another component due to vehicle movement, passage of time, or other factors. As such, the male alignment features may become disengaged from corresponding female alignment features.

### SUMMARY OF THE INVENTION

In one aspect, an elastically averaged alignment system is provided. The system includes a first component comprising a tubular alignment member, a second component comprising an inner wall defining an alignment aperture, the alignment aperture configured to receive the alignment member to couple the first component and the second component, and a third component comprising a locking member configured for insertion into the alignment member. The alignment member is an elastically deformable material such that when the alignment member is inserted into the alignment aperture and/or the locking member is inserted into the alignment member, the alignment member elastically deforms to an elastically averaged final configuration to facilitate aligning the first component and the second component in a desired orientation. The locking member is an elastically deformable material such that when the locking member is inserted into the alignment member, the locking member elastically deforms and forces the alignment member outward toward the inner wall to facilitate securing the first component to the second component in the desired orientation.

In another aspect, a vehicle is provided. The vehicle includes a body and an elastically averaged alignment system integrally arranged within the body. The elastically averaged alignment system includes a first component comprising a tubular alignment member, a second component comprising an inner wall defining an alignment aperture, the alignment aperture configured to receive the alignment member to couple the first component and the second component, and a third component comprising a locking member configured for insertion into the alignment member. The alignment member is an elastically deformable material such that when the alignment member is inserted into the alignment aperture and/or the locking member is inserted into the alignment member, the alignment member elastically deforms to an elastically averaged final configuration to facilitate aligning the first component and the second component in a desired orientation. The locking member is an elastically deformable material such that when the locking member is inserted into the alignment member, the locking member elastically deforms and forces the alignment member outward toward the inner wall to facilitate securing the first component to the second component in the desired orientation.

In yet another aspect, a method of manufacturing an elastically averaged alignment system is provided. The method includes forming a first component comprising a tubular alignment member, forming a second component comprising an inner wall defining an alignment aperture, the alignment aperture configured to receive the alignment member to couple the first component and the second component, and forming a third component comprising a locking member configured for insertion into the alignment member. The method further includes forming the alignment member from an elastically deformable material such that when the alignment member is inserted into the alignment aperture and/or the locking member is inserted into the alignment member, the alignment member elastically deforms to an elastically averaged final configuration to facilitate aligning the first component and the second component in a desired orientation, and forming the locking member from an elastically deformable material such that when the locking member is inserted into the alignment member, the locking member elastically deforms and forces the alignment member outward toward the inner wall to facilitate securing the first component to the second component in the desired orientation.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a perspective view of an exemplary elastically averaged mating system before assembly;

FIG. 2 is a cross-sectional view of the system shown in FIG. 1 after a first assembly step;

FIG. 3 is a cross-sectional view of the system shown in FIGS. 1 and 2 after assembly;

FIG. 4 is an alternative embodiment of the elastically averaged mating system;

FIG. 5 is another alternative embodiment of the elastically averaged mating system; and

FIG. 6 is a side view of a vehicle that may use any of the elastically averaged alignment systems shown in FIGS. 1-5.

### DETAILED DESCRIPTION

The following description is merely exemplary in nature and is not intended to limit the present disclosure, its application or uses. For example, the embodiments shown are applicable to vehicle components, but the system disclosed herein may be used with any suitable components to provide securement and elastic averaging for precision location and alignment of all manner of mating components and component applications, including many industrial, consumer product (e.g., consumer electronics, various appliances and the like), transportation, energy and aerospace applications, and particularly including many other types of vehicular components and applications, such as various interior, exterior, electrical and under hood vehicular components and applications. It should be understood that throughout the drawings, corresponding reference numerals indicate like or corresponding parts and features.

As used herein, the term “elastically deformable” refers to components, or portions of components, including component features, comprising materials having a generally elastic deformation characteristic, wherein the material is configured to undergo a resiliently reversible change in its shape, size, or both, in response to application of a force. The force causing the resiliently reversible or elastic deformation of the material may include a tensile, compressive, shear, bending or torsional force, or various combinations of these forces. The elastically deformable materials may exhibit linear elastic deformation, for example that described according to Hooke's law, or non-linear elastic deformation.

Elastic averaging provides elastic deformation of the interface(s) between mated components, wherein the average deformation provides a precise alignment, the manufacturing positional variance being minimized to Xₘᵢₙ, defined by Xₘᵢₙ=X/√N, wherein X is the manufacturing positional variance of the locating features of the mated components and N is the number of features inserted. To obtain elastic averaging, an elastically deformable component is configured to have at least one feature and its contact surface(s) that is over-constrained and provides an interference fit with a mating feature of another component and its contact surface(s). The over-constrained condition and interference fit resiliently reversibly (elastically) deforms at least one of the at least one feature or the mating feature, or both features. The resiliently reversible nature of these features of the components allows repeatable insertion and withdrawal of the components that facilitates their assembly and disassembly. In some embodiments, the elastically deformable component configured to have the at least one feature and associated mating feature disclosed herein may require more than one of such features, depending on the requirements of a particular embodiment. Positional variance of the components may result in varying forces being applied over regions of the contact surfaces that are over-constrained and engaged during insertion of the component in an interference condition. It is to be appreciated that a single inserted component may be elastically averaged with respect to a length of the perimeter of the component. The principles of elastic averaging are described in detail in commonly owned U.S. Pat. No. 8,695,201, the disclosure of which is incorporated by reference herein in its entirety. The embodiments disclosed above provide the ability to convert an existing component that is not compatible with the above-described elastic averaging principles, or that would be further aided with the inclusion of an elastic averaging system as herein disclosed, to an assembly that does facilitate elastic averaging and the benefits associated therewith.

Any suitable elastically deformable material may be used for the mating components and alignment features disclosed herein and discussed further below, particularly those materials that are elastically deformable when formed into the features described herein. This includes various metals, polymers, ceramics, inorganic materials or glasses, or composites of any of the aforementioned materials, or any other combinations thereof suitable for a purpose disclosed herein. Many composite materials are envisioned, including various filled polymers, including glass, ceramic, metal and inorganic material filled polymers, particularly glass, metal, ceramic, inorganic or carbon fiber filled polymers. Any suitable filler morphology may be employed, including all shapes and sizes of particulates or fibers. More particularly any suitable type of fiber may be used, including continuous and discontinuous fibers, woven and unwoven cloths, felts or tows, or a combination thereof. Any suitable metal may be used, including various grades and alloys of steel, cast iron, aluminum, magnesium or titanium, or composites thereof, or any other combinations thereof. Polymers may include both thermoplastic polymers or thermoset polymers, or composites thereof, or any other combinations thereof, including a wide variety of co-polymers and polymer blends. In one embodiment, a preferred plastic material is one having elastic properties so as to deform elastically without fracture, as for example, a material comprising an acrylonitrile butadiene styrene (ABS) polymer, and more particularly a polycarbonate ABS polymer blend (PC/ABS). The material may be in any form and formed or manufactured by any suitable process, including stamped or formed metal, composite or other sheets, forgings, extruded parts, pressed parts, castings, or molded parts and the like, to include the deformable features described herein. The elastically deformable alignment features and associated component may be formed in any suitable manner. For example, the elastically deformable alignment features and the associated component may be integrally formed, or they may be formed entirely separately and subsequently attached together. When integrally formed, they may be formed as a single part from a plastic injection molding machine, for example. When formed separately, they may be formed from different materials to provide a predetermined elastic response characteristic, for example. The material, or materials, may be selected to provide a predetermined elastic response characteristic of any or all of the elastically deformable alignment features, the associated component, or the mating component. The predetermined elastic response characteristic may include, for example, a predetermined elastic modulus.

As used herein, the term vehicle is not limited to just an automobile, truck, van or sport utility vehicle, but includes any self-propelled or towed conveyance suitable for transporting a burden.

Described herein are alignment and retention systems having a component with an alignment aperture to receive an elastically deformable alignment member of another component. The alignment member is configured to be inserted into the alignment aperture, and the alignment member elastically deforms to facilitate precisely aligning the components together in a desired orientation. An elastically deformable locking member is then coupled to the alignment member to facilitate securing the mated components in the desired orientation.

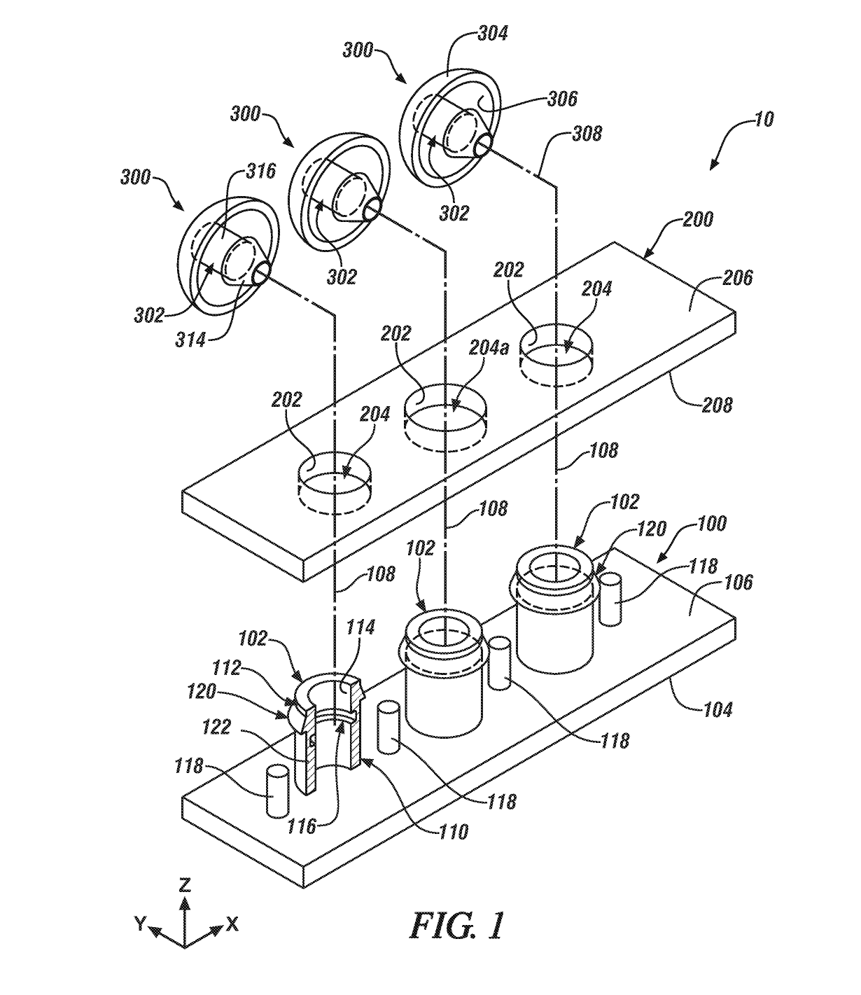

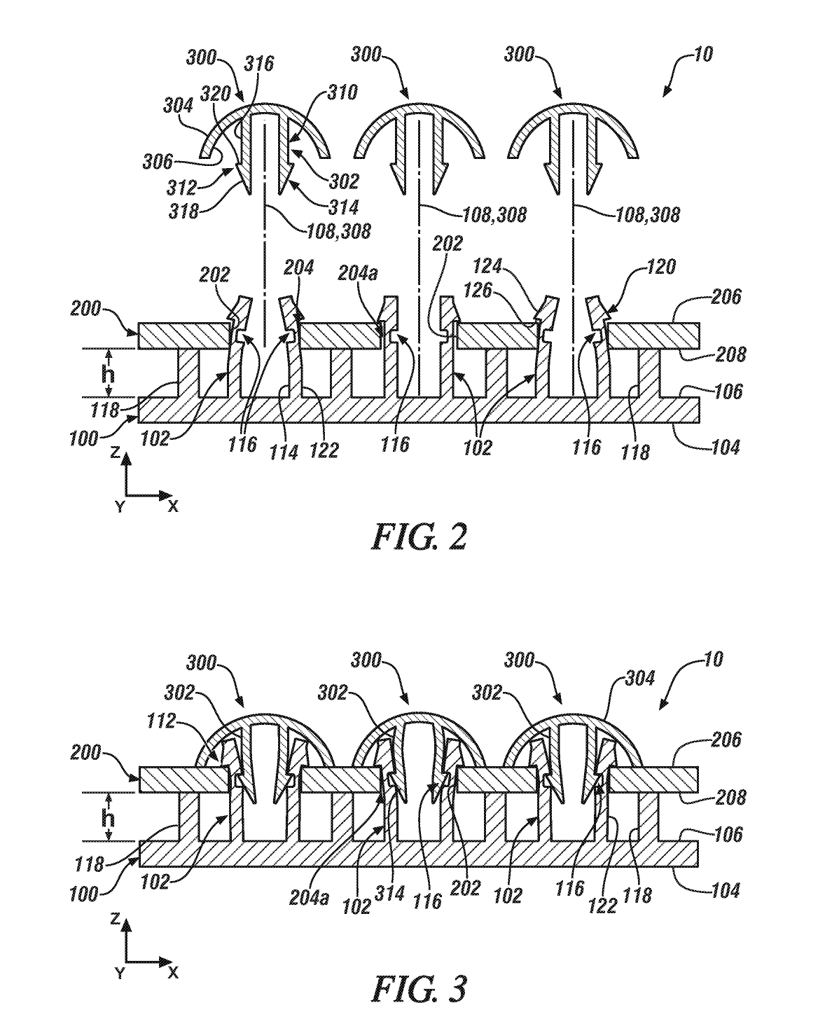

FIGS. 1-3 illustrate an exemplary elastically averaged alignment system 10 that generally includes a first component 100 to be mated to a second component 200. The mated engagement between first and second components 100, 200 is secured by a locking component 300. FIG. 1 illustrates system 10 before assembly, FIG. 2 illustrates system 10 after a first assembly step, and FIG. 3 illustrates system 10 after assembly.

In the exemplary embodiment, first component 100 includes an elastically deformable alignment member 102, second component 200 includes an inner wall 202 defining an alignment aperture 204, and locking component 300 includes an elastically deformable locking member 302. Alignment member 102 and alignment aperture 204 are fixedly disposed on or formed integrally with their respective component 100, 200 for proper alignment and orientation when components 100 and 200 are mated. Although three alignment members 102 and alignment apertures 204 are illustrated, components 100 and 200 may have any number and combination of corresponding alignment members 102 and alignment apertures 204. Moreover, locking component 300 may have any number of locking members 302.

Elastically deformable alignment member 102 is configured and disposed to interferingly, deformably, and matingly engage alignment aperture 204, as discussed herein in more detail, to precisely align first component 100 with second component 200 in two or four directions, such as the +/−x-direction and the +/−y-direction of an orthogonal coordinate system, for example, which is herein referred to as two-way and four-way alignment.

Elastically deformable locking member 302 is configured and disposed to interferingly, deformably, and matingly engage alignment member 102, as discussed herein in more detail, to elastically deform (or further elastically deform) alignment member 102 and lock or secure first component 100 to second component 200.

In the exemplary embodiment, first component 100 generally includes an outer face 104 and an inner face 106 from which alignment member 102 extends. Alignment member 102 is a generally circular hollow tube having a central axis 108, a proximal end 110 coupled to inner face 106, and a distal end 112. However, alignment member 102 may have any cross-sectional shape that enables system 10 to function as described herein. For example, alignment member 102 may be tri-lobular, rectangular, or diamond shaped. Alignment member 102 includes an inner surface 114 having an engagement or locking channel or notch 116 formed therein, which may extend partially through member 102 (as shown) or fully through member 102 about a portion of its circumference. Moreover, notch 116 may extend about the entirety of, or any portion of, the circumference of alignment member 102.

First component 100 may optionally include one or more stand-offs 118 for engaging and supporting second component 200, and distal end 112 may include a retention member 120 extending outwardly from an alignment member outer surface 122 and configured to engage second component 200. In the exemplary embodiment, first component 100 is fabricated from an elastically deformable material such as plastic. However, first component 100 may be fabricated from any suitable material that enables system 10 to function as described herein

Second component 200 generally includes an outer face 206 and an inner face 208. In the exemplary embodiment, alignment aperture 204 is illustrated as having a generally circular cross-section. Alternatively, alignment aperture 204 may have any shape that enables system 10 to function as described herein. For example, alignment aperture 204 may be an elongated slot (e.g., similar to the shape of elastic tube alignment system described in co-pending U.S. patent application Ser. No. 13/187,675 and particularly illustrated in FIG. 13 of the same). In the exemplary embodiment, second component 200 is fabricated from a rigid material such as sheet metal. However, second component 200 may be fabricated from any suitable material that enables system 10 to function as described herein.

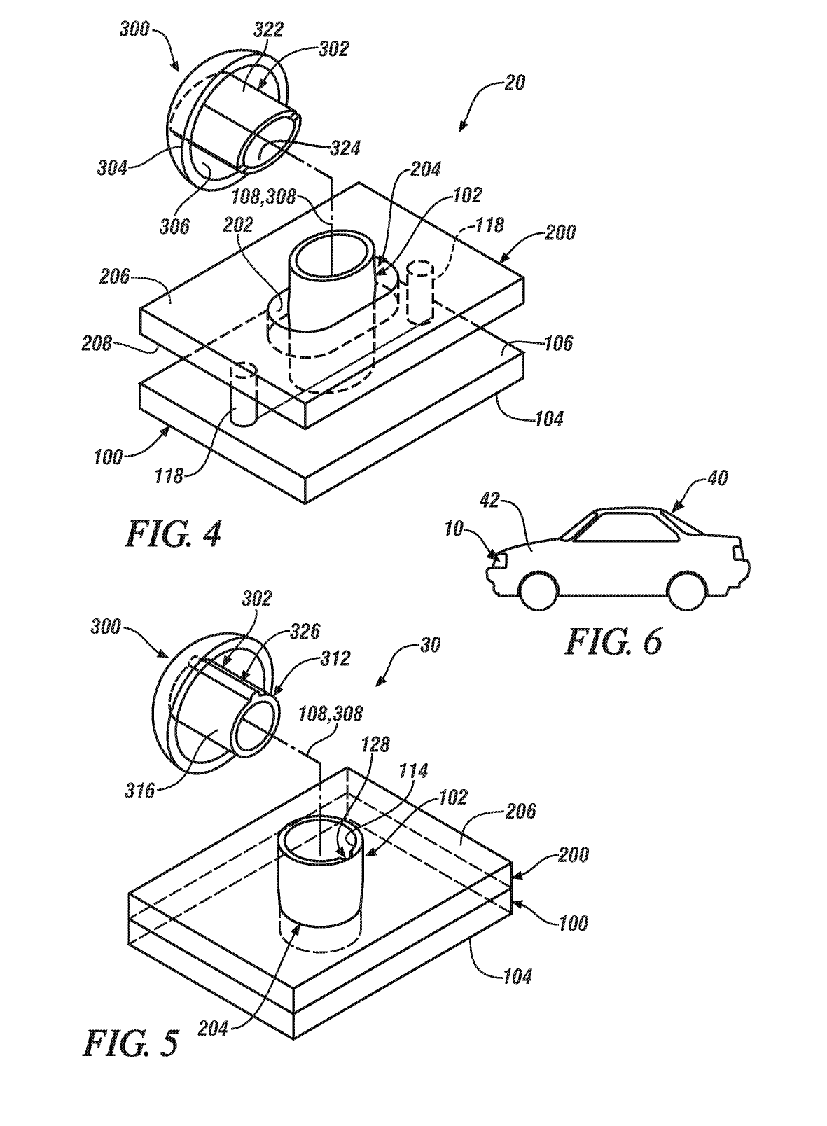

Locking component 300 generally includes an outer face 304 and inner face 306 from which locking member 302 extends. Locking member 302 is a generally circular hollow tube having a central axis 308, a proximal end 310 coupled to inner face 306, and a distal end 312. However, locking member 302 may have any cross-sectional shape that enables system 10 to function as described herein. For example, locking member 302 may be elongated or oval shaped and have a plurality of tabs or sections (see FIG. 4). Distal end 312 includes a projection or engagement member 314 extending outwardly from a locking member outer surface 316 and configured to engage locking notch 116. In the exemplary embodiment, locking component 300 is fabricated from an elastically deformable material such as plastic. However, locking component 300 may be fabricated from any suitable material that enables system 10 to function as described herein.

While not being limited to any particular structure, first component 100 may be a decorative trim component of a vehicle with the customer-visible side being outer face 104, and second component 200 may be a supporting substructure that is part of, or is attached to, the vehicle and on which first component 100 is fixedly mounted in precise alignment.

To provide an arrangement where elastically deformable alignment member 102 is configured and disposed to interferingly, deformably and matingly engage alignment aperture 204, the size of the diameter or cross-section of alignment aperture 204 is less than the size of the diameter or cross-section of alignment member 102, which necessarily creates a purposeful interference fit between the elastically deformable alignment member 102 and alignment aperture 204. As such, when inserted into alignment aperture 204, portions of the elastically deformable alignment member 102 elastically deform to an elastically averaged final configuration that aligns alignment member 102 with the alignment aperture 204 in four planar orthogonal directions (the +/−x-direction and the +/−y-direction). Where alignment aperture 204 is an elongated slot (e.g., FIG. 4), alignment member 102 is aligned in two planar orthogonal directions (e.g., the +/−y-direction). However, when utilizing locking component 300, in some embodiments, second component may include an alignment aperture 204a having a larger diameter or cross-section than alignment member 102 (see FIG. 2).

To provide an arrangement where elastically deformable locking member 302 is configured and disposed to interferingly, deformably and matingly engage alignment member 102, the size of the inner diameter or cross-section of alignment member 102 is less than the size of the outer diameter or cross-section of locking member 302, which necessarily creates a purposeful interference fit between the elastically deformable members 102, 302. As such, when inserted into alignment member 102, portions of the elastically deformable locking member 302 elastically deform alignment member 102 outward from central axis 108 such that distal end 112 bends outward (FIG. 3). This facilitates increased contact between alignment member outer surface 122 and inner wall 202 and, when present, positions retention member 120 in contact with (or in close proximity to) second component outer surface 206 to thereby lock or secure first component 100 in the desired orientation relative to second component 200. In addition, after insertion, engagement member 314 is at least partially inserted or seated in locking notch 116 to lock or secure locking member 302 within alignment member 102.

As shown in FIGS. 2 and 3, with alignment member 204a, it is the insertion of locking member 302 into alignment member 102 that causes alignment member 102 to elastically and bend outward over inner wall 202 to the elastically averaged final configuration that aligns alignment member 102 with alignment aperture 204 in two or four planar orthogonal directions.

Alignment member 102 includes retention member 120 to facilitate retention of alignment member 102 within alignment aperture 204 when locking member 302 is inserted into alignment member 102. In the exemplary embodiment, retention member 120 includes an insertion surface 124 and a retention surface 126. Insertion surface 124 extends angularly from alignment member outer surface 122 and facilitates insertion of alignment member 102 into alignment aperture 204. After insertion, and after insertion of locking member 302 into alignment member 102, retention surface 126 engages or is in close proximity to outer surface 206 to facilitate preventing alignment member 102 from backing out or otherwise being removed from alignment aperture 204, 204a. In the exemplary embodiment, retention member 122 has a generally triangular cross-section. Alternatively, retention member 122 may have any suitable shape that enables system 10 to function as described herein. As such, retention member 122 facilitates improved retention of alignment member 102 within alignment aperture 204, 204a.

Locking member 302 includes engagement member 314 to facilitate insertion and retention of locking member 302 within alignment member 102. In the exemplary embodiment, engagement member 314 includes an insertion surface 318 and a retention surface 320. Insertion surface 318 extends angularly from locking member outer surface 316 and facilitates insertion of locking member 302 into alignment member 102. After insertion, retention surface 320 engages locking notch 116 to facilitate preventing locking member 302 from backing out or otherwise being removed from alignment member 102. In the exemplary embodiment, engagement member 314 has a generally triangular cross-section. Alternatively, engagement member 314 may have any suitable shape that enables system 10 to function as described herein. Accordingly, engagement member 314 and locking notch 116 facilitate improved retention of locking member 302 within alignment member 102.

Standoffs 118 may be spaced relative to alignment member 102 such that they provide a support platform at a height “h” above first component inner face 106. Second component inner face 208 is in contact with standoffs 118 when elastically deformable alignment member 102 is inserted into alignment aperture 204. Standoffs 118 are disposed and configured to provide a final positional orientation between alignment aperture 204 and elastically deformable alignment member 102 at an elevation “h” (FIGS. 2 and 3) above the base, inner face 108. While FIG. 1 depicts four standoffs 118 in the form of posts at a height “h” relative to component inner face 108, it will be appreciated that the scope of the invention is not so limited and also encompasses other numbers and shapes of standoffs 118 suitable for a purpose disclosed herein, and also encompasses a standoff in the form of a continuous ring (not shown) disposed around alignment member 102. Embodiments having such standoff arrangements are contemplated and considered within the scope of the invention disclosed herein. Moreover, while FIGS. 1-3 depict standoffs 118 integrally formed on inner face 106, it will be appreciated that a similar function may be achieved by integrally forming standoffs 118 on inner face 208, which is herein contemplated and considered to be within the scope of the invention disclosed herein. Alternatively, system 10 may not include standoffs.

While FIGS. 1-3 depict three elastically deformable alignment members 102 in a corresponding aperture 204 to provide four-way alignment of the first component 100 relative to the second component 200, it will be appreciated that the scope of the invention is not so limited and encompasses other quantities and types of elastically deformable alignment elements used in conjunction with the elastically deformable alignment member 102 and corresponding aperture 204.

FIG. 4 illustrates an alternative embodiment alignment system 20 that is similar to alignment system 10 except system 20 includes geometric features to facilitate coupling between locking member 302 and alignment member 102 in a desired orientation. Specifically, in the exemplary embodiment, alignment aperture 204 is formed as an elongated slot, and locking member 302 is formed with opposed curved or crescent-shaped tabs 322 and 324. As such, when alignment member 102 is inserted into elongated slot 204, locking member 302 may only be inserted into alignment member 102 when the length of locking member 302 is aligned with the length of elongated slot 204. As such, the geometric shape of elongated slot 204 and tabs 322, 324 allows for only two orientations for installation (i.e., as shown and locking member 302 rotated 180°).

FIG. 5 illustrates another alternative embodiment alignment system 30 that is similar to alignment system 10 except system 30 includes locating features 128 and 326 to facilitate coupling between locking member 302 and alignment member 102 in a desired orientation. Specifically, in the exemplary embodiment, alignment member 102 includes a locating channel 128 formed therein, and locking member 302 includes a locating rib 326. As such, in order to insert locking member 302 into alignment member 102, locking member 302 must be oriented to align locating rib 326 with locating channel 128. In this way, locating channel 128 receives locating rib 326 when locking member 302 is inserted into alignment member 102. Locating features 128 allow for only a single orientation for installation. Alternatively, members 102, 302 may include multiple locating features 128, 326.

In view of all of the foregoing, and with reference now to FIG. 6, it will be appreciated that an embodiment of the invention also includes a vehicle 40 having a body 42 with an elastically averaging alignment system 10 as herein disclosed integrally arranged with the body 42. In the embodiment of FIG. 6, the elastically averaging alignment system 10 is depicted forming at least a portion of a front grill of the vehicle 40. However, it is contemplated that an elastically averaging alignment system 10 as herein disclosed may be utilized with other features or components of vehicle 40, such as interior door trim, console components, trunk closeouts, liners, bins, and pockets. As such, elastically averaging alignment system 10 may be utilized to facilitate various configurations of interior systems and components.

An exemplary method of fabricating elastically averaged alignment system 10 includes forming first component 100 with at least one alignment member 102, forming second component 200 with at least one alignment aperture 204, and forming locking component 300 with at least one locking member. Alignment member 102 is formed with locking notch 116 and may be formed with retention member 120. Locking member 302 is formed with engagement member 314. Alignment member 102 may also be formed with locating channel 128 and locking member 302 may be formed with locating rib 326.

Systems and methods for retention of elastically averaged mating assemblies are described herein. The systems generally include a first component with an elastically deformable alignment member positioned for insertion into an alignment aperture of a second component. The mating of the first and second components is elastically averaged over corresponding pair(s) of elastically deformable alignment members and alignment apertures to precisely mate the components in a desired orientation. A third component with an elastically deformable locking member is positioned for insertion into the alignment member to further elastically deform the alignment member and lock or secure the orientation between the first, second, and/or third components. Moreover, the alignment member and locking member may include retention features to facilitate retention of the alignment member within the alignment aperture. Accordingly, the described systems and methods facilitate precise alignment of two or more components in a desired orientation.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An elastically averaged alignment system comprising:
a first component comprising a tubular alignment member;
a second component comprising an inner wall defining an alignment aperture, the alignment aperture configured to receive the alignment member to couple the first component and the second component; and
a third component comprising a locking member configured for insertion into the alignment member,
wherein the alignment member is an elastically deformable material such that when the alignment member is inserted into the alignment aperture and/or the locking member is inserted into the alignment member, the alignment member elastically deforms to an elastically averaged final configuration to facilitate aligning the first component and the second component in a desired orientation, and wherein the locking member is an elastically deformable material such that when the locking member is inserted into the alignment member, the locking member elastically deforms and forces the alignment member outward toward the inner wall to facilitate securing the first component to the second component in the desired orientation.

2. The system of claim 1, wherein the locking member includes an outer surface having an engagement member extending therefrom, and the alignment member includes an inner surface having a notch formed therein, the notch configured to receive the engagement member when the locking member is inserted into the alignment member.

3. The system of claim 2, wherein the engagement member includes an angularly extending insertion face configured to facilitate insertion of the locking member into the alignment member, and a retention face configured to engage the notch to facilitate preventing removal of the locking member from the alignment member.

4. The system of claim 1, wherein the alignment member includes a retention member extending therefrom.

5. The system of claim 4, wherein the retention member includes an angularly extending insertion face configured to facilitate insertion of the alignment member into the alignment aperture, and a retention face configured to engage a portion of the second component to facilitate preventing removal of the alignment member from the alignment aperture.

6. The system of claim 1, wherein the alignment member includes a locating channel and the locking member includes a locating rib, wherein the locating channel is configured to receive the locating rib when the locking member is inserted into the alignment member.

7. The system of claim 1, wherein the third component comprises more than one locking member.

8. A vehicle comprising:
a body; and
an elastically averaged alignment system integrally arranged within the body, the elastically averaged alignment system comprising:
a first component comprising a tubular alignment member;
a second component comprising an inner wall defining an alignment aperture, the alignment aperture configured to receive the alignment member to couple the first component and the second component; and
a third component comprising a locking member configured for insertion into the alignment member,
wherein the alignment member is an elastically deformable material such that when the alignment member is inserted into the alignment aperture and/or the locking member is inserted into the alignment member, the alignment member elastically deforms to an elastically averaged final configuration to facilitate aligning the first component and the second component in a desired orientation, and wherein the locking member is an elastically deformable material such that when the locking member is inserted into the alignment member, the locking member elastically deforms and forces the alignment member outward toward the inner wall to facilitate securing the first component to the second component in the desired orientation.

9. The vehicle of claim 8, wherein the locking member includes an outer surface having an engagement member extending therefrom, and the alignment member includes an inner surface having a notch formed therein, the notch configured to receive the engagement member when the locking member is inserted into the alignment member.

10. The vehicle of claim 9, wherein the engagement member includes an angularly extending insertion face configured to facilitate insertion of the locking member into the alignment member, and a retention face configured to engage the notch to facilitate preventing removal of the locking member from the alignment member.

11. The vehicle of claim 8, wherein the alignment member includes a retention member extending therefrom.

12. The system of claim 11, wherein the retention member includes an angularly extending insertion face configured to facilitate insertion of the alignment member into the alignment aperture, and a retention face configured to engage a portion of the second component to facilitate preventing removal of the alignment member from the alignment aperture.

13. The system of claim 8, wherein the alignment member includes a locating channel and the locking member includes a locating rib, wherein the locating channel is configured to receive the locating rib when the locking member is inserted into the alignment member.

14. The system of claim 8, wherein the third comprises more than one locking member.

15. A method of manufacturing an elastically averaged alignment system, the method comprising:
forming a first component comprising a tubular alignment member;
forming a second component comprising an inner wall defining an alignment aperture, the alignment aperture configured to receive the alignment member to couple the first component and the second component;
forming a third component comprising a locking member configured for insertion into the alignment member;
forming the alignment member from an elastically deformable material such that when the alignment member is inserted into the alignment aperture and/or the locking member is inserted into the alignment member, the alignment member elastically deforms to an elastically averaged final configuration to facilitate aligning the first component and the second component in a desired orientation; and
forming the locking member from an elastically deformable material such that when the locking member is inserted into the alignment member, the locking member elastically deforms and forces the alignment member outward toward the inner wall to facilitate securing the first component to the second component in the desired orientation.

16. The method of claim 15, further comprising:
forming the locking member with an outer surface having an engagement member extending therefrom; and
forming the alignment member with an inner surface having a notch formed therein, the notch configured to receive the engagement member when the locking member is inserted into the alignment member.

17. The method of claim 16, further comprising forming the engagement member with an angularly extending insertion face configured to facilitate insertion of the locking member into the alignment member, and a retention face configured to engage the notch to facilitate preventing removal of the locking member from the alignment member.

18. The method of claim 15, further comprising forming the alignment member with a retention member extending therefrom.

19. The method of claim 18, further comprising forming the retention member with an angularly extending insertion face configured to facilitate insertion of the alignment member into the alignment aperture, and a retention face configured to engage a portion of the second component to facilitate preventing removal of the alignment member from the alignment aperture.

20. The method of claim 15, further comprising:
forming the alignment member with a locating channel; and
forming the locking member with a locating rib, wherein the locating channel is configured to receive the locating rib when the locking member is inserted into the alignment member.
